(19) United States
(12) Patent Application Publication
(10) Pub. No.: US 2009/0248507 A1
(43) Pub. Date: Oct. 1, 2009

(54) COMPUTER SYSTEM AND METHOD FOR PRESENTING ADVERTISEMENT BASED UPON TIME AND/OR LOCATION

(75) Inventors: Salem Hamaoui, Largo, FL (US); Mitchell I. Heller, Bloomington, IN (US); Ian J. Shepherd, Beverly Hills, FL (US); Anthony B. Mickle, Homosassa, FL (US)

Correspondence Address: LARSON AND LARSON, 11199 69TH STREET NORTH, LARGO, FL, 33773, US

(73) Assignee: GO SURFBOARD TECHNOLOGIES, INC., Largo, FL (US)

(21) Appl. No.: 12/059,397

(22) Filed: Mar. 31, 2008

(51) Int. Cl. G06Q 30/00; G06F 15/16

(52) U.S. Cl. 705/14; 709/203

(57) ABSTRACT

An application for a computer system that provides content and advertising to users includes a server computer, a user computer, one or more sources of content and one or more sources of advertisements. Software running on the server computer accesses content from the one or more sources of content based upon requests from the user computer. The software also selects an advertisement from the one or more sources of advertisements based upon one or both of a location of the user computer and a time at the user computer. The software then sends the content and the selected advertisement to the user computer for display.

### CROSS-REFERENCE TO RELATED APPLICATION

This application is related to U.S. application titled, “Computer System and Method for Presenting Custom Views based upon Time and/or Location,” which was filed on even date herewith; attorney docket number 2432.1 and inventors Salem I. Hamaoui, Mitchell I. Heller, Ian Shepherd and Anthony B. Mickle. Additionally, this application is related to U.S. application titled, “Computer System and Method for Billing for Advertisements based upon Time-in-view,” which was filed on even date herewith; attorney docket number 2432.2 and inventors Salem I. Hamaoui, Mitchell I. Heller, Ian Shepherd and Anthony B. Mickle. Additionally, this application is related to U.S. application titled, “Computer System and Method for Billing for Advertisement based upon User Activity while Displayed,” which was filed on even date herewith; attorney docket number 2432.3 and inventors Salem I. Hamaoui, Mitchell I. Heller, Ian Shepherd and Anthony B. Mickle.

### FIELD OF THE INVENTION

This invention relates to the field of advertising and more particularly to a system for presenting advertisements to Internet users and for billing based upon the user's activities during the display of such an advertisement.

### BACKGROUND OF THE INVENTION

The Internet has become a remarkable success in the past 15 years. Part of its success is its ubiquitous availability with access to almost every person in the country, either from home, work or public access stations. One of the driving forces behind the Internet's success is advertising. Advertisers pay large sums of money for you to see their advertisements when you check your stocks, see what the weather will be, buy something, look up information, etc. Every time you visit you home page, whether it be msn.com, yahoo.com or google.com, advertisements are presented.

Presently, advertisers are billed for the number of times a user views their advertisement, known as the number of impressions. For example, when you access your favorite portal such as yahoo.com and an advertisement for a product is displayed at the top of the screen, an impression is counted. An impression is a flat count and does not take into consideration how long the advertisement remains on your display. Furthermore, once displayed, the browser that is displaying the advertisement is sometimes forced into the background, where the advertisement is no longer visible to the user.

Furthermore, in some systems, advertisers are billed each time a user clicks on the advertisement, whether or not the user actually completes a transaction (e.g., buys something). This is often referred to as a click-through (the user clicks on the advertisement and is passed to the advertiser's web site).

The Internet has a vast amount of content and pages to visit. Often, users of the Internet visit the same locations on a daily or weekly basis. For example, a user might check the weather, traffic and news before leaving home and the stock market when returning home. A software system called a personal portal is known in the industry to organize the user's information and browsing habits. The portal keeps track of regularly browsed web pages (links) and is capable of aggregating data from multiple web sites or data sources onto a single web page (view). Presently, there is no way for the user to customize their portal based upon their location or the time-of-day. For example, some user desires that the user be presented the weather, traffic and news when they access their portal in the morning and the stock market when they access their portal in the evening. Furthermore, the user's needs vary between work and home. For example, at work, a different look (one suitable for the workplace) along with work-related links is desired while at home, a more fun-look is desired. Such a system is currently not available.

Currently, favorites are typically tracked by a browser residing on a user's personal computer. Favorites provide fast access to frequently viewed web pages. Since the set of favorites are stored locally on the user's personal computer, when the user visits another computer, their favorites are not present. For example, if the user has favorites on his/her home computer for Fidelity, E*TRADE, Google and Hertz; when the user visits another computer, say a computer in a library, the user no longer has access to the favorites. One known service called Del.icio.us (http://del.icio.us.com) offers some amount of portable favorites, but it does not provide for different presentation of favorites based upon the user's location and/or the time of day.

What is needed is a system that will present selected advertisements based upon the time-of-day and location of the user.

### SUMMARY OF THE INVENTION

In one embodiment, a computer system providing content and advertising to users is disclosed including a server computer, a user computer, one or more sources of content and one or more sources of advertisements. Software running on the server computer accesses content based upon requests from the user computer from the one or more sources of content. The software also selects an advertisement from the one or more sources of advertisements based upon one or both of a location of the user computer and a time at the user computer. The software then sends the content and the selected advertisement to the user computer for display.

In another embodiment, a method of providing content and advertising to users is disclosed including accepting a request for content from a user the retrieving the content. At least one of a location of the user and a time at the location of the user is determined and an advertisement is selected based upon the at least one of a time and a location of the user. The content and the advertisement are sent to the user for display.

In another embodiment, a computer system providing content and advertising to users is disclosed including a server computer, a user computer and software executing on the server computer for providing content and advertising to the user computer in response to a request from the user computer. The software has algorithms for providing the content and algorithms for selecting one or more advertisements from a set of advertisements. The algorithms for selecting use at least one of a time at the user computer and a location of the user computer to determine which advertisement of the set of advertisements to select.

In another embodiment, a computer program product for selecting an advertisement to be sent to a user computer system is disclosed. The computer program product comprises a computer usable storage medium having computer readable instructions embodied in the medium. The computer readable instructions include computer readable instructions using one or both of a time at the user computer system and a location of the user computer system for searching a set of advertisements for an advertisement to be sent to the user computer system. The advertisement is selected based upon an attribute that matches one of the location of the user computer system and the time at the location of the user computer system. Additional computer readable instructions download the advertisement to the user computer system.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system of the present invention.

FIG. 2 illustrates a schematic view of the data relationships of the present invention.

FIG. 3 illustrates a typical user interface of the present invention.

FIG. 4 illustrates a typical user interface of the present invention with a new advertisement.

FIG. 5 illustrates a typical user interface of the present invention with a new advertisement.

FIG. 6 illustrates a typical user interface of the present invention with a new advertisement.

FIG. 7 illustrates a typical user interface of the present invention with a different application in the foreground.

FIG. 8 illustrates a first flow chart of the present invention.

FIG. 9 illustrates a second flow chart of the present invention.

FIG. 9A illustrates a typical advertisement selection table of the present invention.

FIG. 10 illustrates a third flow chart of the present invention.

FIG. 11 illustrates a fourth flow chart of the present invention.

FIGS. 12A and 12B illustrates a fifth flow chart of the present invention.

FIG. 13 illustrates a sixth flow chart of the present invention.

FIG. 14 illustrates an exemplary billing record of advertisements of the present invention.

FIG. 15 illustrates a seventh flow chart of the present invention.

FIG. 16 illustrates a second exemplary billing record of advertisements of the present invention.

FIG. 17 illustrates an exemplary billing summary of advertisements of the present invention.

FIG. 18 illustrates a typical computer system of the present invention.

FIG. 19 illustrates a typical list of favorites according to the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

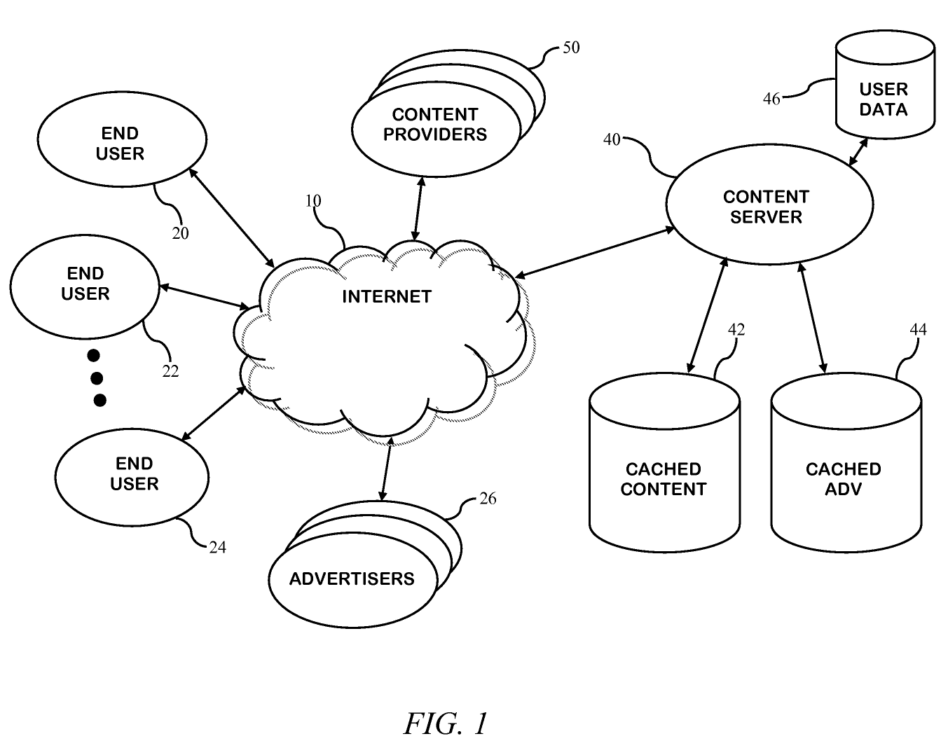

Referring to FIG. 1, a schematic view of a system of the present invention is shown. Although the present invention works well with any known network, it is preferred to operate with the Internet 10, e.g., the World Wide Web. The present invention provides any number of end users 20/22/24 with a customize portal for accessing web content. The customized portal provides content from content providers 50, advertisements from advertisers 26 through a customized look that is provided by the content server 40. The customized look also provides continuity data so that as the users 20/22/24 relocate from one computer to another, much of their data is available when they need it. For example, a user's 20/22/24 favorites are stored in the user data 46 and are available at their home computer system as well as at a different computer system such as a shared computer in a library, etc. In some embodiments, content is cached in a content cache 42 for efficiency and other purposes. In some embodiments, advertisements are cached in an advertisement cache 44 for efficiency and other purposes.

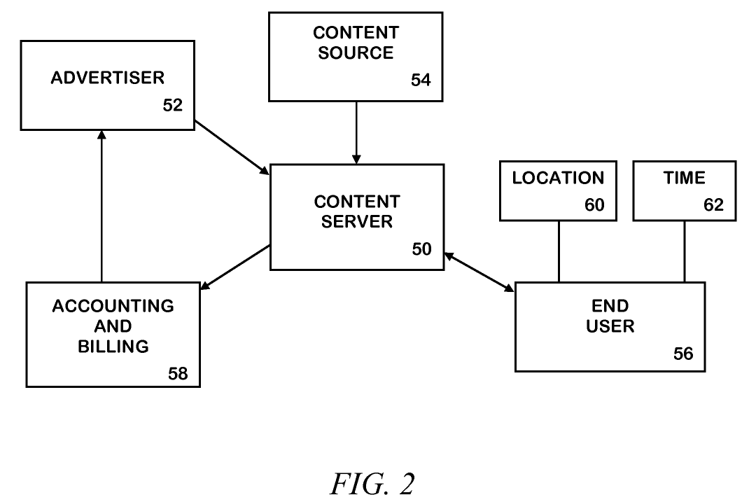

Referring to FIG. 2, a schematic view of the data relationships of the present invention is shown. In general, the end user 56 is interested in receiving and viewing content from some content source 54 such as news, information, weather, sports information and the like. It is known for a user 56 to connect to a content server 50 to access such content. The content server 50 either has the content stored locally or accesses the content from the content source 54. Also well known in the industry is to provide the user advertising mixed in with the content. Payment for the advertising by advertisers 52 is known to generate revenue for the content providers 54. To account for this advertising, the content server 50 records user actions and accesses to the advertising with an accounting and billing system 58. Periodically (e.g., monthly), the billing system 58 remits a bill to the advertiser 52.

Prior to the present invention, the billing system recorded the number of times a particular advertisement is displayed and the number of times an end user 56 clicks on the advertisement (e.g., accesses the advertisement). With the present invention, more useful information is kept regarding the viewing history of the end user 56 including the time 62 the advertisement was displayed/viewed and the location of viewing 60. Additionally, the location 60 of the user and time-of-day at the user's location 62 is used by the content server 50 to determine which advertisements are presented.

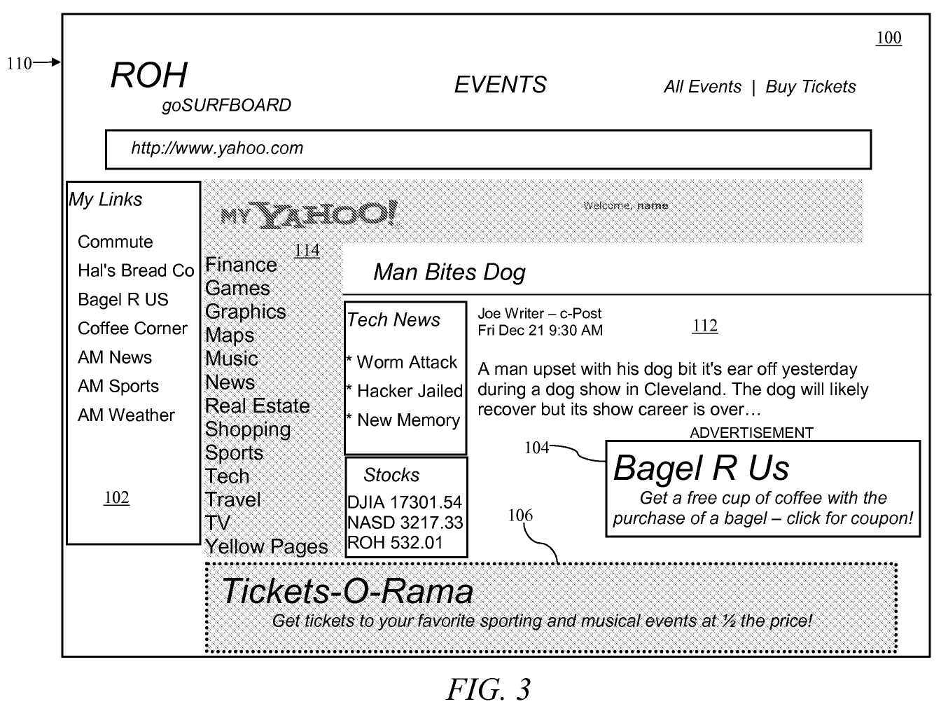

Referring to FIG. 3, a typical user interface of the present invention is shown. In this exemplary user interface 100, it is morning and the user is viewing a news article presented by yahoo.com. The information section 112 includes a news article titled: “Man Bites Dog.” In this typical user interface 100, the user has customized the look of their browsing environment 110. In this example, the customization has some text (ROH, etc.) but it is anticipated that such customization will include color schemes, graphics and text. In some embodiments, the customization will include themes such as sporting themes (e.g., Tampa Bay Buccaneer colors and logos) or corporate themes (e.g., Apple colors and logo), etc.

Besides the news article, yahoo.com presents a list of links 114 to yahoo.com pages. For example, if the user selects Finance from the yahoo.com links 114, a yahoo.com finance page is presented in the viewing window.

In some embodiments, a set of user favorites or links 102 is presented. In this example, the links 102 include links that are important to the user in the morning such as Commute (traffic report), morning food locations, morning news, morning sports and morning weather. The user is also presented with advertisements 104/106. In the past, the portal (e.g., yahoo.com) presented the advertisements on a random or round-robin schedule to users. As shown, the advertisements 104/106 are presented based upon the user's location and time-of-day. Since it is morning, an advertisement for a bagel shop 104 and an advertisement for ½ price tickets are displayed. Note that existing methods of scheduling advertisements are used to determine which advertisement within a group of morning advertisements is displayed such as random selection, weighted-random selection, round-robin selection, etc.

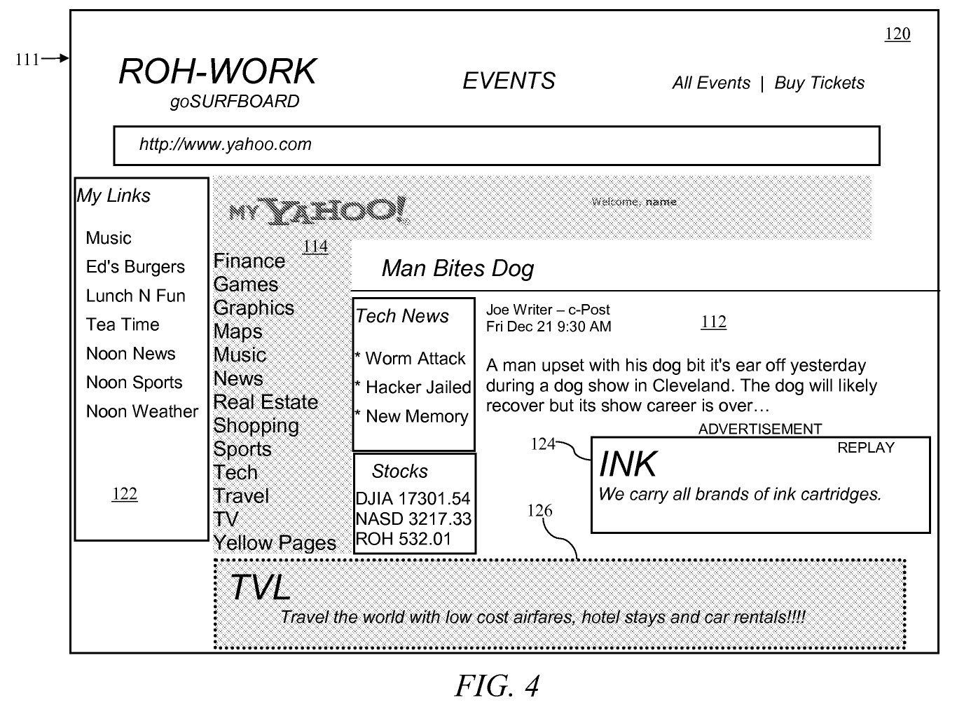

Referring to FIG. 4, a typical user interface of the present invention with a new advertisement is shown. In this exemplary user interface 120, the user is still viewing the same news article presented by yahoo.com, but it is now mid-day, perhaps 11:00 AM to 1:00 PM. The information section 112 includes the news article titled: “Man Bites Dog.” In this typical user interface 120, the user has customized the look of their browsing environment 111. In this example, the afternoon look has some text (ROH-WORK, etc.). It is anticipated that this customized look will include color schemes, graphics and text as in the previous look. In some embodiments, the customized look includes themes such as sporting themes (e.g., Tampa Bay Buccaneer colors and logos) or corporate themes (e.g., Apple colors and logo), etc.

Besides the same news article 112, yahoo.com presents the same list of links 114 to yahoo.com pages. For example, if the user selects Finance from the yahoo.com links 114, a yahoo.com finance page is presented in their viewing window.

In some embodiments, a set of user favorites or links 122 is presented. In this example, since it is lunch time, the links 122 include links that are important to the user in the afternoon such as music, lunch food locations, noon news, noon sports and noon weather. The user is also presented with advertisements 124/126. In this example, the advertisements 124/126 are presented based upon the user's location and time-of-day. Since it is now approximately noon, an advertisement 124 for INK, an on-line office supply company and an advertisement 126 for TVL, a travel company, are displayed. The advertisement 124 for INK is selected because of the user's location—work. Note that as previously described; existing methods of scheduling advertisements are used to determine which advertisement within a group of morning advertisements is displayed such as random selection, weighted-random selection, round-robin selection, etc.

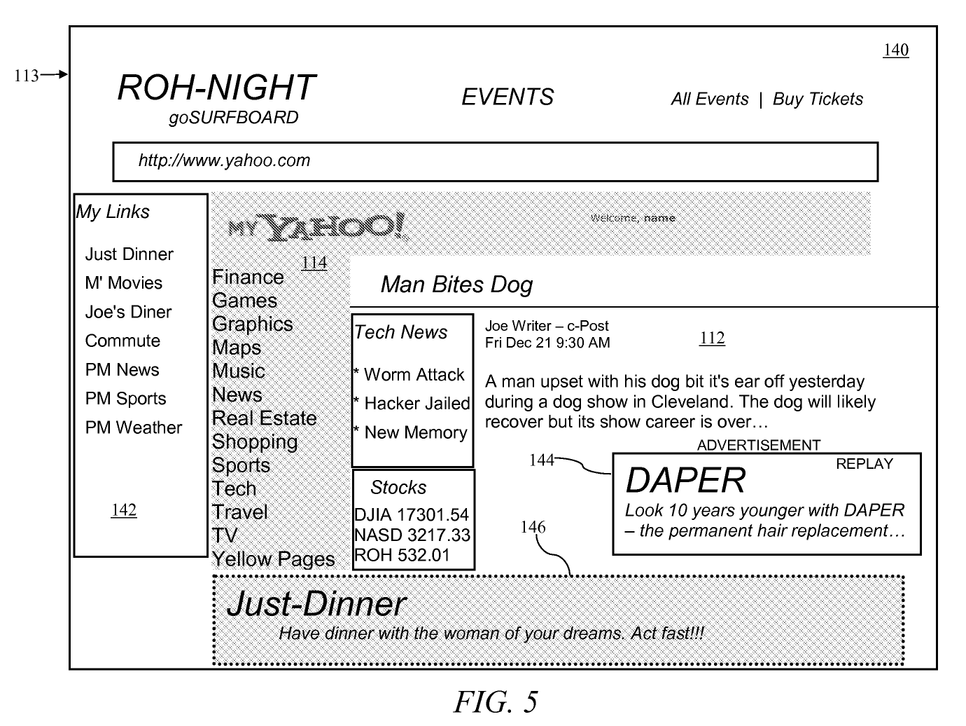

Referring to FIG. 5, a typical user interface of the present invention with a new advertisement is shown. In this exemplary user interface 140, the user is still viewing the news article 112 presented by yahoo.com, but it is now evening. The information section 112 still includes the news article titled: “Man Bites Dog.” In this typical user interface 140, the user has customized the look of their browsing environment 113. In this example, the evening look has some text (ROH-NIGHT, etc.). It is anticipated that this customized look will include color schemes, graphics and text as in the previous look. In some embodiments, the customized look includes themes such as sporting themes (e.g., Tampa Bay Buccaneer colors and logos) or corporate themes (e.g., Apple colors and logo), etc.

Besides the same news article 112, yahoo.com presents the same list of links 114 to yahoo.com pages. For example, if the user selects Finance from the yahoo.com links 114, a yahoo.com finance page is presented in their viewing window.

In some embodiments, a set of user favorites or links 142 is presented. In this example, since it is evening, the links 142 include links that are important to the user in the evening such as movies, dinner food locations, evening news, evening sports and evening weather. The user is also presented with advertisements 144/146. In this example, the advertisements 144/146 are presented based upon the user's location and time-of-day. Since it is now evening, an advertisement 144 for DAPER, a hair replacement company and an advertisement 146 for Just-Dinner, a dating service, are displayed. Note that as previously described; existing methods of scheduling advertisements are used to determine which advertisement within a group of morning advertisements is displayed such as random selection, weighted-random selection, round-robin selection, etc.

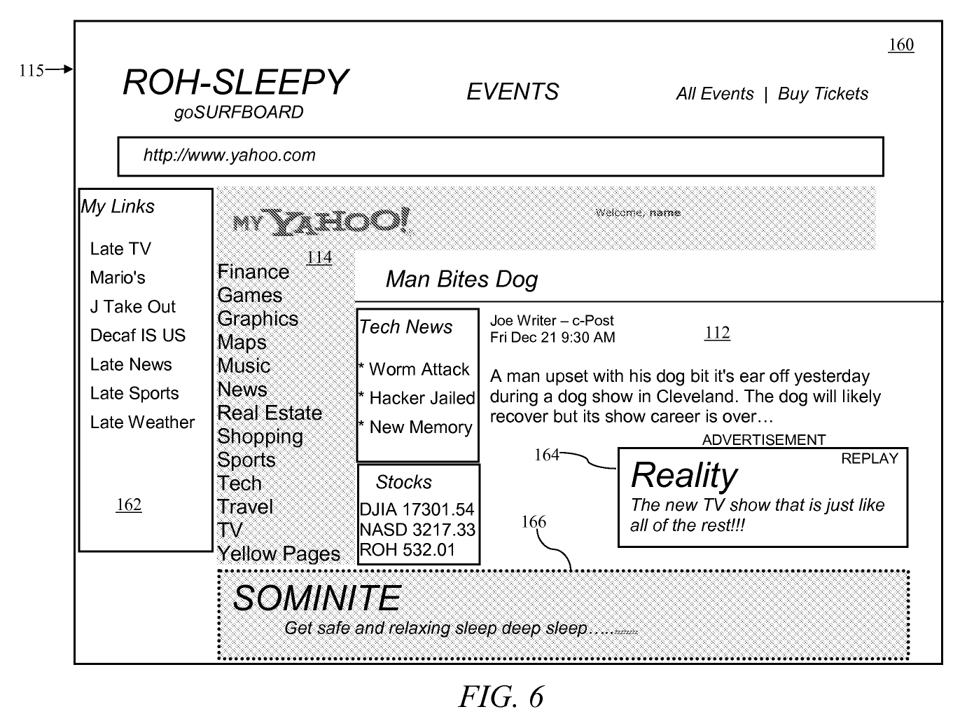

Referring to FIG. 6, a typical user interface of the present invention with a new advertisement is shown. In this exemplary user interface 160, the user is still viewing the news article 112 presented by yahoo.com, but it is now late in the evening. The information section 112 still includes the news article titled: “Man Bites Dog.” In this typical user interface 160, the user has customized the look of their browsing environment 115. In this example, the evening look has some text (ROH-SLEEPY, etc.). It is anticipated that this customized look will include color schemes, graphics and text as in the previous look. In some embodiments, the customized look includes themes such as sporting themes (e.g., Tampa Bay Buccaneer colors and logos) or corporate themes (e.g., Apple colors and logo), etc.

Besides the same news article 112, yahoo.com presents the same list of links 114 to yahoo.com pages. For example, if the user selects Finance from the yahoo.com links 114, a yahoo.com finance page is presented in their viewing window.

In some embodiments, a set of user favorites or links 162 is presented. In this example, since it is late in the evening, the links 162 include links that are important to the user in the late evening such as late TV, take-out food locations, late news, late sports and late weather. The user is also presented with advertisements 164/166. As shown, the advertisements 164/166 are presented based upon the user's location and time-of-day. Since it is now late evening, an advertisement 164 for Reality, a television show and an advertisement 166 for Sominite, a sleeping aid, are displayed. Note that as previously described; existing methods of scheduling advertisements are used to determine which advertisement within a group of morning advertisements is displayed such as random selection, weighted-random selection, round-robin selection, etc.

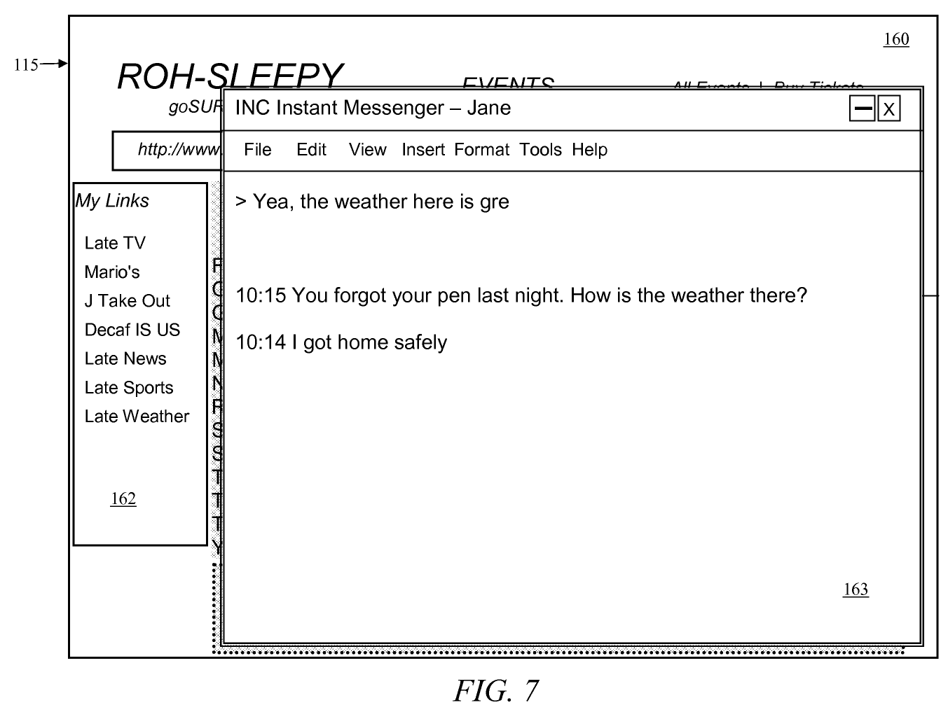

Referring to FIG. 7, a typical user interface of the present invention with a different application in the foreground is shown. This is a typical scenario in which the user was viewing their portal user interface 160 (as in FIG. 6) and while the portal user interface 160 is still partially visible, it is now partially hidden by another application 163; in this example an internet chat session 163. Note how the application 163 overlays the portal user interface 160, thereby hiding the advertisements 164/166 (see FIG. 6). The system of the present invention determines where the advertisements appear (e.g., foreground or hidden). The advertisement being displayed is referred to as an impression and if the advertisement is in the foreground (visible to the user), it is an active impression. In some embodiments, the system of the present invention collects billing data to charge the advertisers differently for active impression duration than inactive impression duration. In some embodiments, charges are made for active impression durations and no charges are made for inactive impression durations. In other embodiments, one cost coefficient is applied for active impression durations and another (preferably lower) cost coefficient is applied for inactive impression durations.

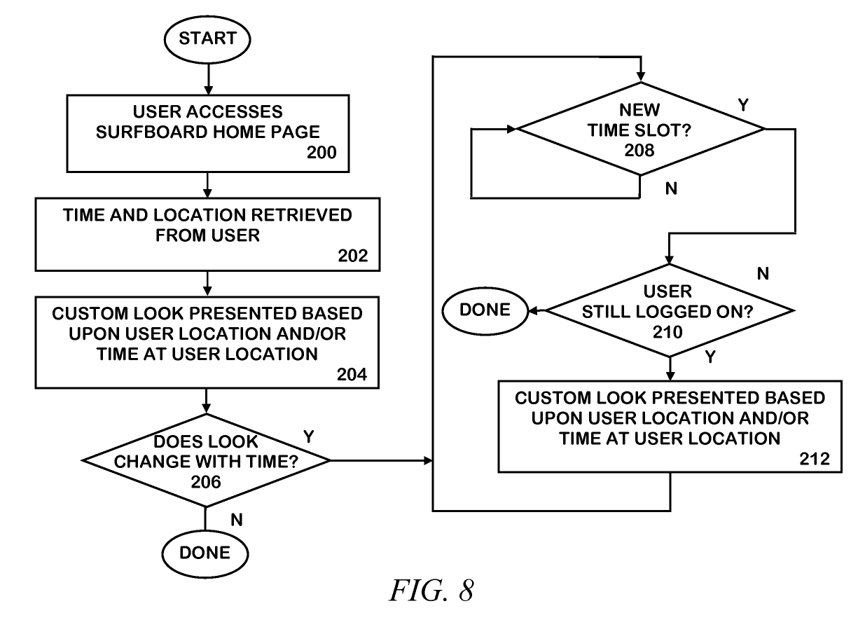

Referring to FIG. 8, a first flow chart of the present invention is shown. The process begins when the user accesses the portal or surfboard home page 200. The time and location is accessed 202 from the user's local computer system. In the preferred embodiment, the user enters their location at their local computer system. In some embodiments, the location is generic locations such as “home,” “work,” or “school.” In some embodiments, the location is a specific location such as latitude and longitude (Cartesian coordinates), an address or a zip code. In other embodiments, the location is read from hardware associated with the user's computer system. An example of such hardware is a Global Positioning System (GPS). The system of the present invention uses the location to present user-selected or system-selected views, advertisements and/or environments. For example, the user's home view/environment has a football team motif and links to home-related web sites; whereas, the user's work view/environment has a work-related motif and links to work-related web sites. In the example where the user specifies there location by latitude and longitude, address or a zip code; advertisements are targeted to the user's specific locality. For example, when the user is at a zip code serviced by a particular restaurant, advertisements for that restaurant are presented. When the user is in a different zip code, different advertisements are presented.

The time is entered at the user's computer system as known in the industry and the computer system's clock tracks the time. The system of the present invention reads the computer system's clock to determine the time and forwards that to the content server. In alternate embodiments, the user enters their time zone and it is stored at their computer system or in the content server. With this, the content server determines the time at the user's location. Similar to location, the time is used to present user-selected or system-selected views and/or environments and/or advertisements. In some embodiments, the user has different views and/or environments for morning, evening, afternoon, late-night, etc. For example, the user has a bright view and/or environment for morning and a darker a view and/or environment for the evening with different sets of links, etc.

The process continues with generating a custom look/view 204 based upon the user location and/or time. If the system is enabled to change the look at various times 206, the system waits for the next time slot 208 and when the new time slot occurs 208 and the user is still logged-In 210, a new custom look is presented 212 based upon the users location and time (or time zone) and the process continues to look for the next time slot. The time slot is any arbitrary time period selected by the user or the system. In some embodiments, the time slot is an approximate time such as morning, afternoon, evening; each having a specific set of time ranges associated with them. In other embodiments, the time slot is a range of times such as 6:15 AM to 8:59 AM.

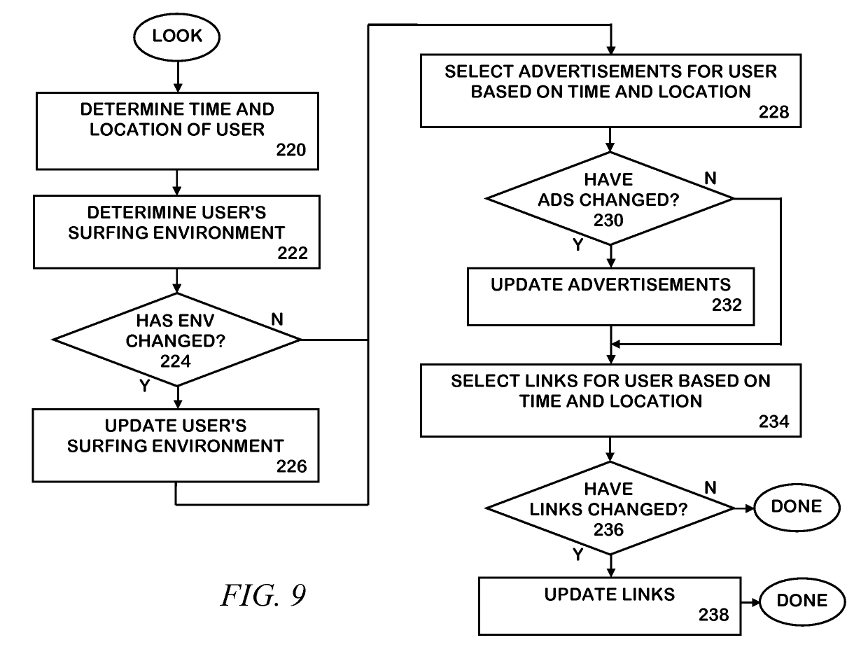

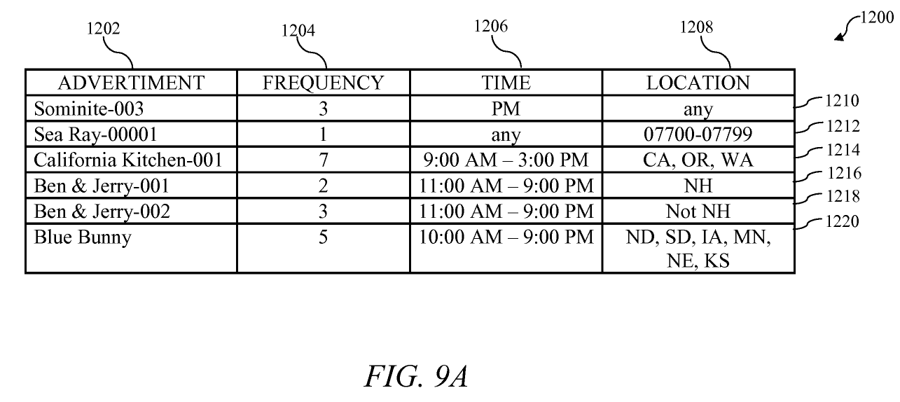

Referring to FIG. 9, a second flow chart of the present invention is shown. This flow describes how the user's look is generated. First, the user's location and time is determined. In some embodiments, the user's location and time are determined by reading server data maintained regarding the user (e.g., user data 46). In other embodiments, the user's location and time are determined by reading local data stored at the user's computer system. In other embodiments, the user's location and time are determined by reading hardware at the user's computer system.

Next, the system determines the user's surfing environment based upon user selections (stored in the content server's 40 user data 46) and the time and location. If the user's environment is different from what is already being presented to the user 224, the system updates the user's environment 226.

Next, one or more advertisements are selected for presentation to the user 228. It is known how to select advertisements from a set of possible advertisements. In the system of the present invention, the known methods are augmented with selection models that are based upon the location of the user and the time at that location. For example, whereas the prior art randomly presents an advertisement for a brand of coffee at any time during the day, the present invention provides mechanisms for advertisers to restrict the times when such an advertisement is presented, say during the morning. Similarly, whereas the prior art randomly presents an advertisement for a brand of yachts, the present invention provides mechanisms for advertisers to restrict presentation of such an advertisement to specific locations such as locations that are close to water.

Once the advertisement is selected, it is determined if the advertisement is already being displayed on the user's browser 230. If it has changed 230, the portion of the user's environment where the advertisement is displayed is updated with the new advertisement 232.

Similarly, a set of user favorites or links are selected based upon the user's location and/or the time at that location 234. For example, if it is morning, the user's links include morning-related links and if it is afternoon, the user's links include afternoon-related links. Likewise, if the user's location is home, the user's links include home-related links and if the user's location is work, the user's links include work-related links. If the new set of links is the same as the previously displayed set of links 236, nothing is updated. If different, the new set of links is used to update the user's environment 238.

Referring to FIG. 9A, a typical advertisement selection table of the present invention is shown. This typical advertisement selection table 1200 is a sample of one possible data representation of advertisements that are eligible to be pushed to a user. Prior to the present invention, a typical advertisement selection table included only advertisement identification and, optionally, a frequency. Such a simple table was used in the prior art to determine which advertisements to push to a user using methods known in the industry such as round-robin, weighted round-robin, random, etc.

Since the present invention has knowledge of each user's time and location, the system of the present invention uses a typical advertisement selection table 1200 to determine which advertisements are eligible to be pushed to a particular user based upon the user's time and/or location. The advertisement selection table 1200 contains identification entries for the possible advertisements 1202. This is known in the industry and includes the advertisement itself, links to advertisements, URLs, etc. The exemplary advertisement selection table 1200 optionally includes a frequency 1204 for each advertisement, as known in the industry. This frequency 1204 field is used to determine how often the associated advertisement is pushed to any random user. In this example, the frequency 1204 is a numeric value, an integer representing a weighting factor. The higher the value, the more times the associated advertisement is presented to users per day. There are many ways known to determine which advertisements are presented over other advertisements and all are included here within.

In addition to the frequency 1204, the present invention includes selection criteria such as time 1206 and/or location 1208. When a user is ready to receive a new advertisement, the time and/or location of the user is used in conjunction with the time 1206 and/or location 1208 fields to determine which advertisements are eligible to be pushed to the user. Each advertisement 1210/1212/1214/1216/1218/1220 has an associated time in which it is eligible for display. For example, advertisement 1210 is eligible for display in the PM hours while advertisement 1216 is eligible for display from 11:00 AM to 9:00 PM and advertisement 1212 is eligible for display at any time. Likewise, each advertisement 1210-1220 has an associated location in which it is eligible for display. For example, advertisement 1210 is eligible for display to users in any location while advertisement 1216 is eligible for display to users in New Hampshire and advertisement 1212 is eligible for display to users in zip codes 07700 through 07799. Therefore, if a user is ready to receive an advertisement and they are located in New Hampshire and it is 1:30 PM at their location, they are eligible for the Sominite-003 advertisement 1210 (any location and PM) and the Ben & Jerry-001 advertisement (NH and 11:00 AM to 9:00 PM). Note that the entries in the time column 1206 and the location column 1208 include simple entries (e.g., PM), ranges (e.g., 07700-07799) and Boolean entries (e.g., not NH). There are many known methods of specifying times, ranges of times, locations and sets of locations; all of which are included here within.

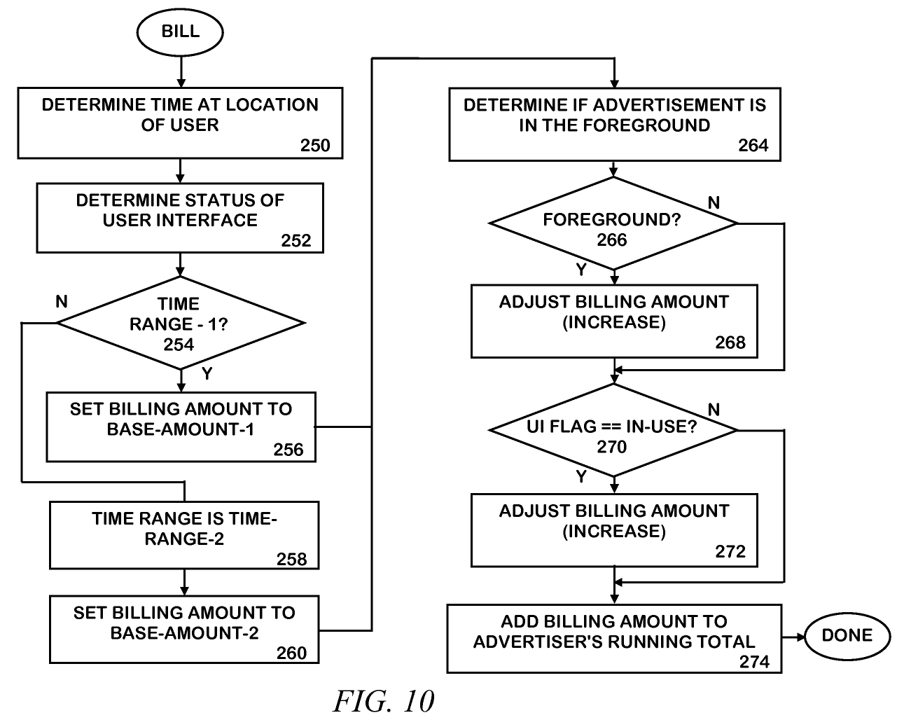

Referring to FIG. 10, a third flow chart of the present invention is shown. This chart shows an exemplary flow used by the system of the present invention to determine how to charge an advertiser for a particular impression. In the past, a flat rate was charged for an impression (e.g., the advertisement was displayed). With the present invention, additional data is available to enhance the billing opportunities. In this example, the time at the user's location is determined 250 either based upon their profile and the current time at the content server 40, by reading the time at the user's computer system or by other methods known in the industry. Next, the status of the user's display is determined 252 providing information regarding the visibility of the advertisement. In this simplified example, there are two time ranges, Time-range-1 and Time-range-2, although there are endless possibilities of time range selection including days of the week (e.g., charging more for advertisements displayed on weekdays), all of which are included here within. If the time range is Time-range-1 254, the billing base amount is set to a first base amount 256. Otherwise it is assumed that the time range is Time-range-2 258 and the billing base amount is set to a second base amount 260. In some embodiments, the base amounts are an agreed upon advertising cost such as $0.0000012 and $0.0000015 (slightly higher charges in Time-range-2). Next, it is determined if the advertisement is in the foreground 264 (visible to the user). If it is in the foreground 266, the billing amount is adjusted 268 since the user is able to view the advertisement. As an example, the billing rate is increased by $0.0000001 to $0.0000013 and $0.0000016, respectively, thereby charging the advertisers slightly more knowing the advertisement is available to the user's eyes.

Next, the UI flag is checked 270. The UI flag is set when the system determines the status of the user interface 252. As an example, the UI flag is either set to “In-use” or “Idle.” For example, “In-use” indicates that the user has typed on their keyboard or moved their mouse within the last five minutes while “Idle” means no activity has transpired for more than five minutes. Again, if the user is active (“In-use”) the advertiser is charged more by adjusting the billing amount 272. For example, the advertiser is charge twice as much; so if the time is Time-Range-1 ($0.0000012 base charge) and the advertisement is visible ($0.0000013 charge) and the user is active, the charge is increased. For example, the charge is doubled if the user is active, to $0.0000026. The resulting amount is written to a billing record and/or added to the advertisers running total 274.

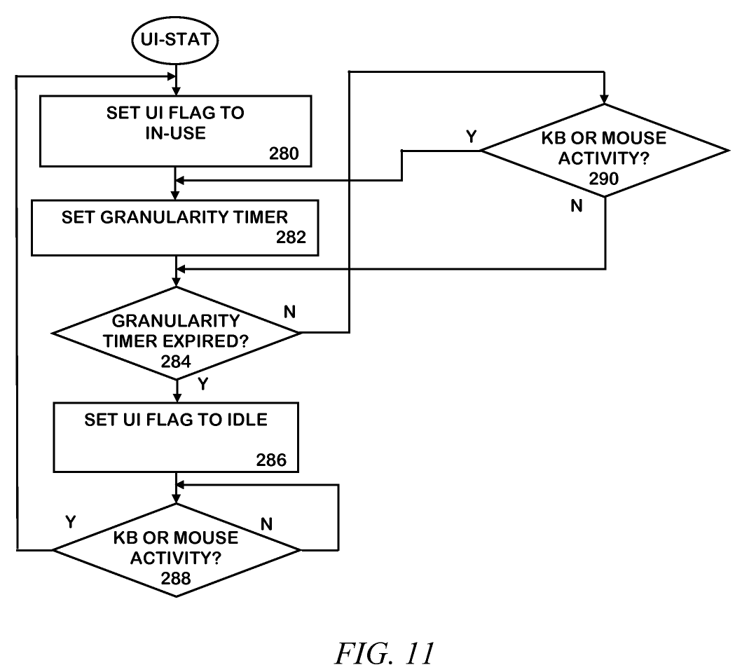

Referring to FIG. 11, a fourth flow chart of the present invention is shown. This shows one possible way to determine if the user is active. There are many ways to determine if the user is active and this is but one example. Other ways include monitoring interrupts such as those generated by mouse or keyboard activity, etc. Furthermore, the described method provides a binary indication, either “Idle” or “In-use;” while other methods provide multiple indications such as “Idle”, “Low-use” and “High-use.” In this example, the UI flag is initially set to “In-Use” 280 and a granularity timer is set 282 to a desired value, for example, five minutes (e.g., if the user hasn't moved the mouse or entered a keyboard stroke in 5 minutes, then the user is “Idle”). If the granularity time has not expired 284, the keyboard and/or mouse are checked for activity 290 and, if there is activity 290, the granularity timer is again set 282 to its initial value. If there is no activity, 290, the granularity timer is again checked 284 until the granularity timer expired 284, at which time the UI flag is set to “Idle” 286 and stays “Idle” until a keyboard or mouse activity 288, at which time the UI flag is set back to “In-Use” 280 and the process continues.

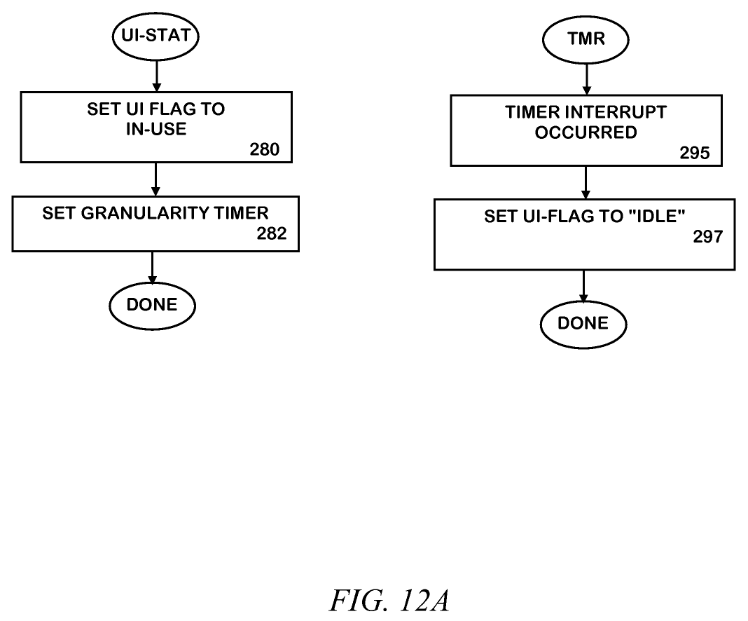

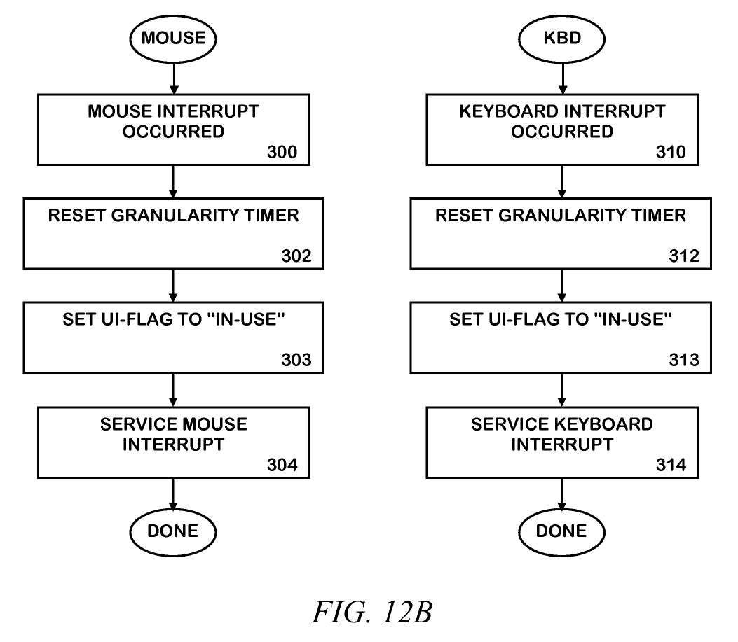

Referring to FIGS. 12A and 12B, a fifth flow chart of the present invention is shown. The process of FIGS. 12-12A show how the system works using an interrupt system. The UI flag is initially set to “In-use” 280 and the granularity timer is set 282 to the desired granularity time (e.g., five minutes). The mouse interrupt service routine and the keyboard interrupt service routines are modified. When a mouse interrupt occurs 300, the granularity timer is reset 302 to its initial value and the UI flag is set to “In-Use” 303 since the user is now active. The mouse interrupt is the serviced 304 as known in the industry. Likewise, when a keyboard interrupt occurs 310, the granularity timer is reset 312 to its initial value and the UI flag is set to “In-Use” 313 since the user is now active. The keyboard interrupt is the serviced 304 as known in the industry. Should the granularity timer expire, a timer interrupt is generated 295 and the interrupt service routine sets the UI flag to “Idle” 297 since the user didn't use the mouse or keyboard since the granularity timer was set. Any use of the keyboard or mouse will set the UI flag back to active 302/312 and reset the granularity timer 303/313.

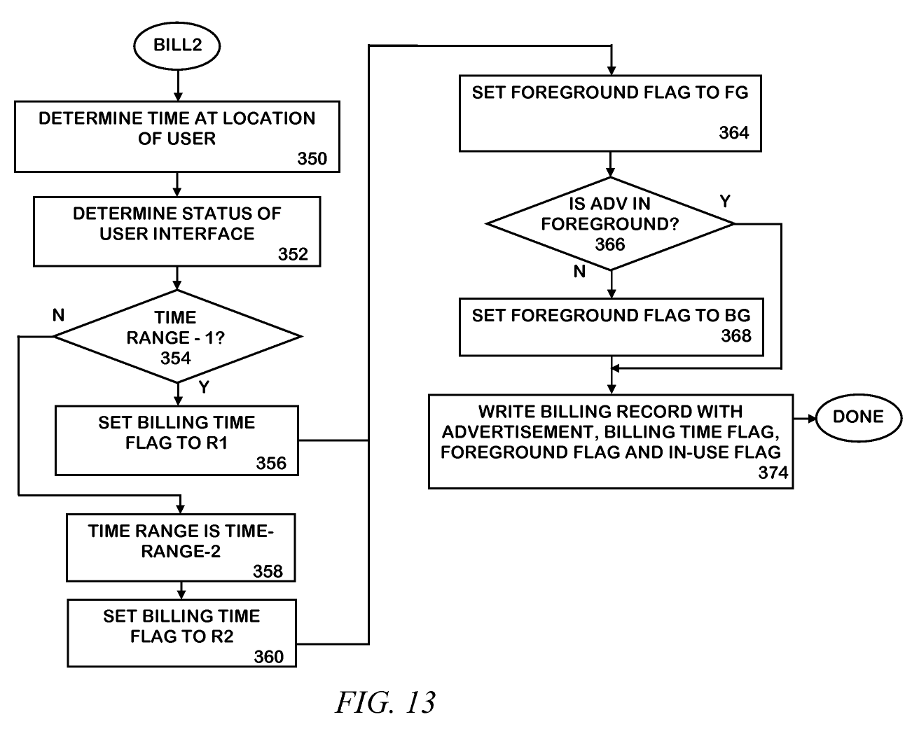

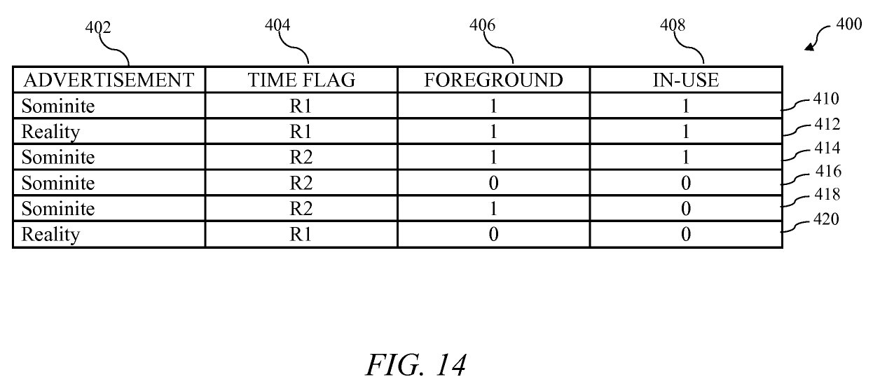

Referring to FIG. 13 and FIG. 14, a sixth flow chart and a sample output record of the present invention is shown. In this exemplary process, a billing record is written to track billing for advertisements. The process begins with determining the time at the location of the user 350 as previously described. Next, the status of the user interface is determined 352 (e.g., foreground or background). If the time at the user's location is in a particular time range (e.g., Time-range-1) 354, a billing flag is set to a first value 356, R1. Otherwise, the time range is a second time range Time-range-2 (or third, etc.) 358 and the billing time flag is set to a second value 360, R2. The foreground flag is defaulted to “foreground” 364. If the status of the user interface indicates that the advertisement is not in the foreground 366, the foreground flag is set to “background” 368. Next a record is written to the billing file including an identification of the advertisement, the billing time flag and the foreground flag. In other embodiments, more or less information is written in the billing record, an example of which is described later.

The sample billing file 400 of FIG. 14 has six billing records 410/412/414/416/418/420. Each billing record 410-420 has an identification of the advertisement 402; the time flag value 404, the foreground flag 406 and the in-use flag 408. For example, the first record 410 is for the advertisement “Sominite” and was billed during the Time-Range-1 since the value in the time flag 404 is “R1.” The advertisement was in the foreground (the value of the Foreground field 406 is 1) and the user was actively using their computer as previously described (value of In-use field 408 is 1). Writing of billing records is well known in the industry as well as processing the billing records to generate billing reports and customer bills. Furthermore, processing the resulting billing records to generate reports and bills is also known in the industry.

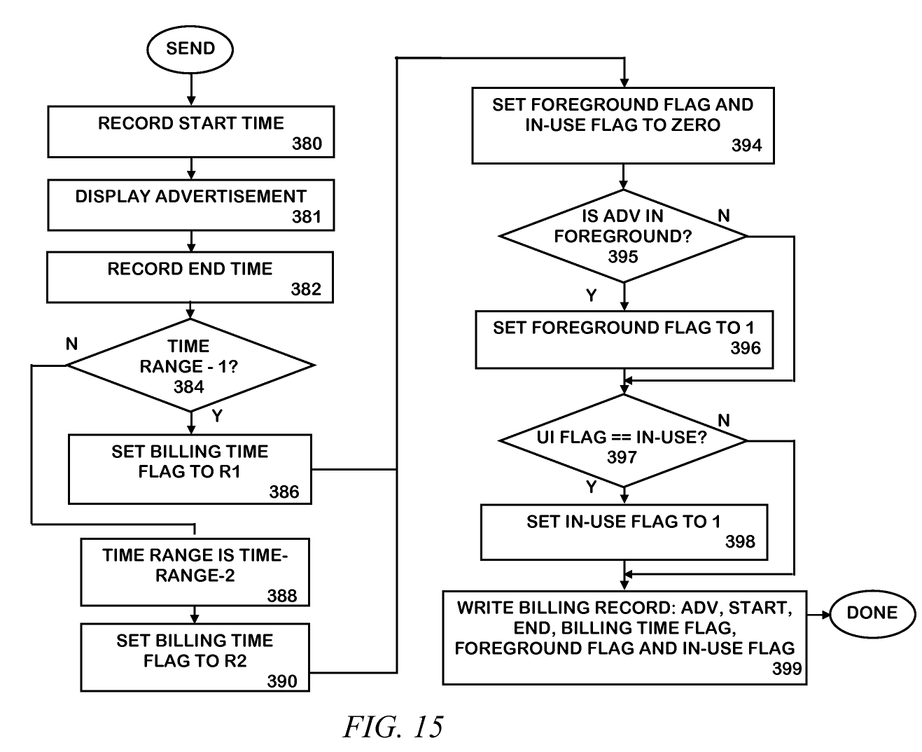

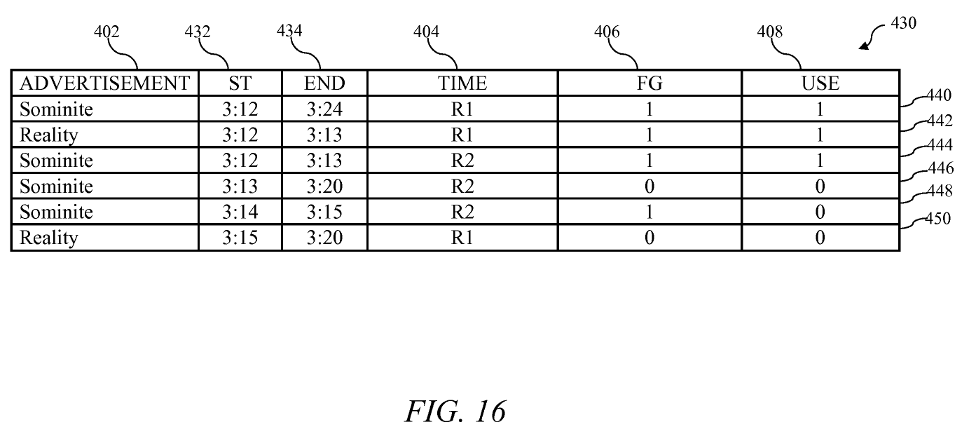

Referring to FIG. 15 and FIG. 16, a seventh flow chart and a sample output record of the present invention is shown. In this exemplary process, a billing record is written to track billing for advertisements. The process begins with recording the start time 380. Next, the advertisement is displayed on the user's interface 381. When the advertisement is no longer displayed at the user's interface, the end time is recorded 382. As with the previous examples, if the time at the user's location is in a particular time range (e.g., Time-range-1) 384, a billing flag is set to a first value 386, R1. Otherwise, the time range is a second time range Time-range-2 (or third, etc.) 388 and the billing time flag is set to a second value 390, R2. The foreground flag is defaulted to “foreground” 394. If the status of the user interface indicates that the advertisement is not in the foreground 395, the foreground flag is set to “background” 396. If the user interface flag indicates that the user was active (In-use) 397, the in-use flag is set 398. Next a record is written to the billing file 399 including an identification of the advertisement, the start time, the end time, the billing time flag, the foreground flag and the in-use flag. In other embodiments, more or less information is written in the billing record, an example of which was previously described.

The sample billing file 430 of FIG. 16 has six billing records 440/442/444/446/448/450. Each billing record 440-450 has an identification of the advertisement 402; the time the advertisement was displayed 432, the time the advertisement was removed 434 (e.g., the session ended or it was replaced by another advertisement); the time flag value 404; the foreground flag 406; and the in-use flag 408. For example, the first record 440 is or the advertisement “Sominite.” The advertisement started 432 being displayed at 3:12 and finished 434 being displayed at 3:24. The advertisement was displayed during the Time-Range-1 since the value in the time flag 404 is “R1.” The advertisement was in the foreground (the value of the Foreground field 406 is 1) and the user was actively using their computer as previously described (value of In-use field 408 is 1). Writing of billing records is well known in the industry as well as processing the billing records to generate billing reports and customer bills. Furthermore, processing the resulting billing records to generate reports and bills is also known in the industry.

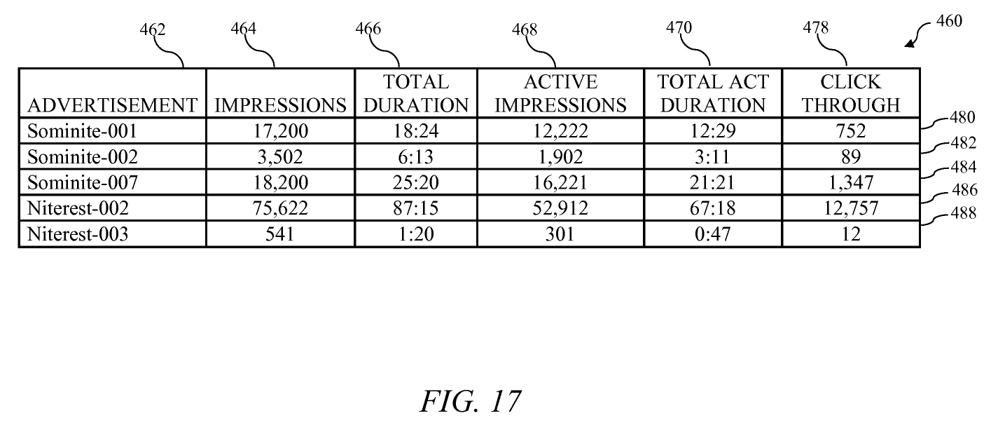

Referring to FIG. 17, an exemplary billing summary of advertisements of the present invention is shown. This exemplary billing summary 460 includes a description or index into the advertisement 462, the total number of impressions 464, the total duration 466, the total impressions while the user was active 468, the total duration while the user was active 470 and the number of click-throughs 478. In this example, there are five summary lines 480/482/484/486/488. For example, the first summary 480 has a description or index of “Sominite-001” 462; a total number of impressions of 17,200 464; a total duration of 18 hours and 24 minutes 466; a total of 12,222 impressions while the user was active 468; a total duration of 12 hours and 29 minutes while the user was active 470; and a 752 click-throughs 478. This granularity of data permits the system to bill at different rates depending upon, for example, the number of times the advertisement was viewed, how long the advertisement was viewed, how long the potential customers actually viewed the advertisement and the number of times the potential customers actually clicked on the advertisement.

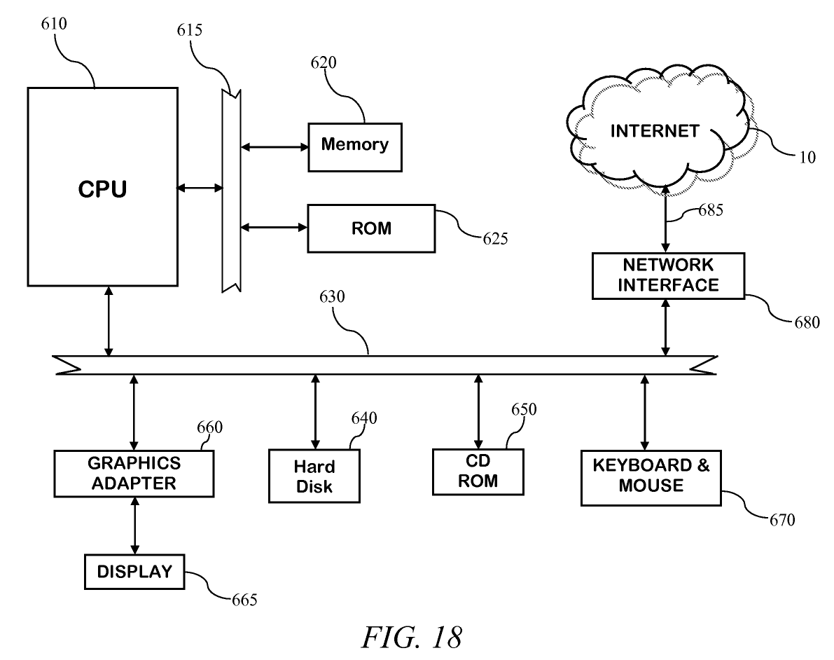

Referring to FIG. 18, an exemplary computer system of the present invention is shown. The example computer system is shown in its simplest form, having a single processor. Many different computer architectures are known that accomplish similar results in a similar fashion and the present invention is not limited in any way to any particular computer system. The present invention works well utilizing a single processor system as shown in FIG. 18, a multiple processor system where multiple processors share resources such as memory and storage, a multiple server system where several independent servers operate in parallel (perhaps having shared access to the data or any combination). In this, a processor 610 is provided to execute stored programs that are generally stored for execution within a memory 620. The processor 610 can be any processor or a group of processors, for example an Intel Pentium-4® CPU or the like. The memory 620 is connected to the processor and can be any memory suitable for connection with the selected processor 610, such as SRAM, DRAM, SDRAM, RDRAM, DDR, DDR-2, etc. Firmware is stored in firmware storage 625 that is connected to the processor 610 and may include initialization software known as BIOS. This initialization software usually operates when power is applied to the system or when the system is reset.

Also connected to the processor 610 is a system bus 630 for connecting to peripheral subsystems such as a network interface 680, a hard disk 640, a CDROM 650, a graphics adapter 660 and a keyboard/mouse 670. The graphics adapter 660 receives commands and display information from the system bus 630 and generates a display image that is displayed on the display 665.

In general, the hard disk 640 may be used to store programs, executable code and data persistently, while the CDROM 650 may be used to load such programs, executable code and data from removable media onto the hard disk 640. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, etc. In some embodiments, other devices are connected to the system through the system bus 230 or with other input-output connections. Examples of these devices include printers; graphics tablets; joysticks; and communications adapters such as modems and Ethernet adapters.

The network interface 680 connects the computer-based system to the Internet 10 through a link 685 which is, preferably, a high speed link such as a cable broadband connection, a Digital Subscriber Loop (DSL) broadband connection, a T1 line or a T3 line.

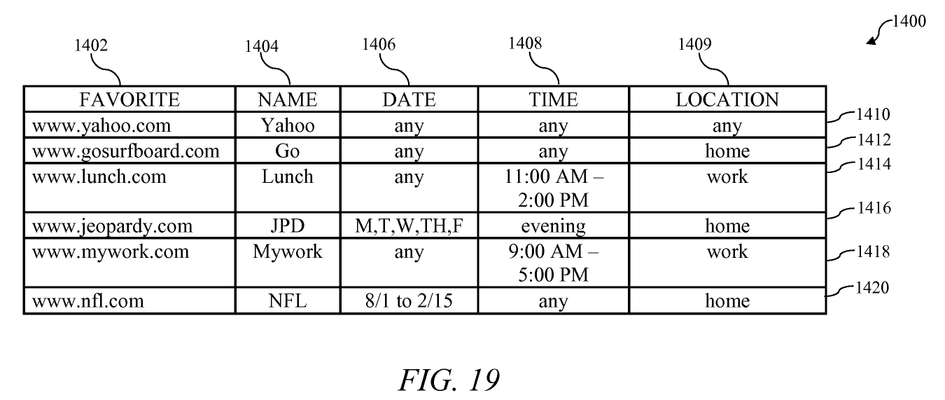

Referring to FIG. 19, a typical list of favorites of the present invention is shown. This typical list of favorites 1400 is a sample of one possible data representation of favorites that a user might maintain. Prior to the present invention, a list of favorites table included only a favorite name and the actual favorite (e.g., URL to the favorite). Such a simple table was used in the prior art to provide a list of favorites to user using methods known in the industry such as a sorted list or an ordered list, etc.

Since the present invention has knowledge of each user's time and location (and date), the system of the present invention uses a typical list of favorites 1400 to determine which favorites are to be pushed to a particular user (for display) based upon the user's time and/or location and/or date. The list of favorites 1400 contains links to the user's favorite locations (e.g., URLs) 1402. This is known in the industry and in some embodiments contains links to other resources such as files, storage systems, etc. The exemplary list of favorites 1400 optionally includes a name 1404 for each link, as known in the industry. This name 1404 provides an easy-to-remember title for the associated link.

In addition to the name 1404, the present invention includes selection criteria such as date 1406, time 1408 and/or location 1409. When a user is ready to receive an updated list of favorites, the time and/or date and/or location of the user is used in conjunction with the date 1406, time 1408 and/or location 1409 fields of the list of favorites 1400 to determine which favorites are appropriate to push to the user. Each favorite 1410/1412/1414/1416/1418/1420 has an associated time in which it is eligible for display. For example, one favorite 1414 is eligible for display any day during the hours between 11:00 AM and 2:00 PM when the user is at work while another favorite 1416 is eligible for display on Mondays-Fridays in the evening when the user is at home. Likewise, still another favorite 1410 is eligible for display at any time, any date and at any location. Each favorite 1410-1420 has an associated location in which it is eligible for display. For example, one favorite 1410 is eligible for display to users when they are in any location while another favorite 1416 is eligible for display to the user when they are at home and another favorite 1418 is eligible for display to a user at work. Note that the entries in the date column 1406, in the time column 1408 and the location column 1409 include simple entries (e.g., PM), ranges (e.g., 07700-07799) and Boolean entries (e.g., not NH). There are many known methods of specifying times, ranges of times, locations and sets of locations; all of which are included here within. Furthermore, algorithms are known in the industry for finding close matches and/or exact matches, all of which are included here within. For example of using closest matches, if a display can fit 20 favorites and 19 exact matches are found (e.g., at work and daytime), a 20^{th} match is added by selecting the closest favorite from the remaining unselected favorites (e.g., a favorite whose location is work and time is closest to daytime).

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A computer system providing content and advertising to users, the computer system comprising:
a server computer;
a user computer;
one or more sources of content;
one or more sources of advertisements;
software running on the server computer, the software retrieves content based upon requests from the user computer from the one or more sources of content and the software selects an advertisement from the one or more sources of advertisements based upon one or both of a location of the user computer and a time at the location of the user computer; and
the software sends the content and the advertisement to the user computer for display.

2. The computer system providing content and advertising to users of claim 1, wherein the time at the location of the user computer is determined by a parameter stored at the server computer.

3. The computer system providing content and advertising to users of claim 2, wherein the parameter is selected from the group consisting of a time zone, a zip code, an address and Cartesian coordinates.

4. The computer system providing content and advertising to users of claim 1, wherein the time at the location of the user computer is uploaded from the user computer.

5. The computer system providing content and advertising to users of claim 1, wherein the location of the user computer is sent from the user computer to the server computer.

6. The computer system providing content and advertising to users of claim 5, wherein the location is selected from the group consisting of a time zone, a zip code, an address, Cartesian coordinates and a location nick name.

7. The computer system providing content and advertising to users of claim 6, wherein the location nick name is selected from the group consisting of home, work and school.

8. The computer system providing content and advertising to users of claim 1, wherein each advertisement of the at least one advertisement includes selection criteria and the software uses the selection criteria to determine which of the advertisements are eligible for selection.

9. The computer system providing content and advertising to users of claim 9, wherein the selection criteria includes at least one criteria selected from the group consisting of a time, a date, a location, a set of times, a set of dates, a set of locations a range of times and a range of dates.

10. A method of providing content and advertising to users comprising:
(a) accepting a request for content from a user computer system;
(b) retrieving the content from a source of content;
(c) determining at least one of a location of the user computer system and a time at the location of the user computer system;
(d) determining an advertisement based upon the at least one of the time at the location of the user computer system and the location of the user computer system;
(e) sending the content and the advertisement to the user computer system for display.

11. The method of providing content and advertising to users of claim 10, wherein the step of determining at least one of a location of the user computer system and a time at the location of the user computer system includes determining the time at the location of the user computer system by reading a parameter stored at a server computer system.

12. The method of providing content and advertising to users of claim 11, wherein the parameter is selected from the group consisting of a time zone, a zip code, an address and Cartesian coordinates.

13. The method of providing content and advertising to users of claim 10, wherein the step of determining at least one of a location of the user computer system and a time at the location of the user computer system includes uploading the time at the location of the user computer system from the user computer system to a server computer system.

14. The method of providing content and advertising to users of claim 10, the step of determining the location of the user computer system includes reading a profile of a user.

15. The method of providing content and advertising to users of claim 14, wherein the location of the user computer system is selected from the group consisting of a time zone, a zip code, an address, Cartesian coordinates and a location nick name.

16. The method of providing content and advertising to users of claim 10, wherein there is a plurality of potential advertisements and each of the potential advertisements includes selection criteria and the step of determining an advertisement based upon the at least one of a time and a location of the user computer system includes reading the selection criteria and determining if the at least one of the location of the user computer system and the time at the location of the user computer system is within the selection criteria.

17. The method of providing content and advertising to users of claim 16, wherein the selection criteria includes at least one criteria selected from the group consisting of a set of times, a set of dates and a set of locations.

18. A computer system providing content and advertising to users, the computer system comprising:
a server computer;
a user computer;
software executing on the server computer for providing content and a target advertisement to the user computer in response to a request from the user computer, the software having a means for providing the content and a means for selecting the target advertisement from a set of advertisements; and
software executing on the server computer for sending the content and the target advertisement to the user computer;
whereas, the means for selecting the target advertisement uses at least one of a time at the user computer and a location of the user computer.

19. The computer system providing content and advertising to users of claim 18, wherein each advertisement of the set of advertisements includes selection criteria and the software uses the selection criteria to determine which of the advertisements in the set of advertisements are eligible for selection.

20. The computer system providing content and advertising to users of claim 19, wherein the selection criteria includes at least one criteria selected from the group consisting of a set of times, a set of dates and a set of locations.

21. A computer program product for selecting an advertisement to be sent to a user computer system, the computer program product comprising a computer usable storage medium having computer readable instructions embodied in the medium, the computer readable instructions comprising:
(a) computer readable instructions for using one or both of a time at a user computer system and a location of the user computer system in selecting a target advertisement from a set of advertisements, each advertisement in the set of advertisements having at least one attribute selected from the group consisting of a location attribute and a time attribute; and
(b) computer readable instructions for downloading the target advertisement to the user computer system.

22. The computer program product for selecting an advertisement of claim 21, wherein the time attribute is selected from the group consisting of a set of times, a set of dates and a range of times.

23. The computer program product for selecting an advertisement of claim 21, wherein the location of the user computer system is selected from the group consisting of a time zone at the user computer system, a zip code at the user computer system, an address at the user computer system, Cartesian coordinates at the user computer system and a location nick name of the user computer system.
